(19) United States
(12) Patent Application Publication
(10) Pub. No.: US 2005/0053087 A1
(43) Pub. Date: Mar. 10, 2005

(54) Ethernet converter

(76) Inventor: Garry Allen Pulyk, Mannville (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/891,237

(22) Filed: Jul. 13, 2004

(30) Foreign Application Priority Data
Sep. 10, 2003 (CA) 2,440,314

(51) Int. Cl. H04L 12/413

(52) U.S. Cl. 370/463

(57) ABSTRACT

An ethernet converter enables computers with an ethernet connection to connect to a network on a two-wire system. The converter comprises a device installed behind a wall plate that employs an RJ11 port. The converter may comprise indicator lights, which notifies the user of the status of the converter. The converter may comprise a cable for connecting the computer to the device, and for connecting the device to a power source, which may be a USB port or a PS/2 port of the computer, or an AC/DC adapter connected to an AC power source.

### BACKGROUND OF THE INVENTION

There is an increasing demand for network accessibility in many areas, such as the hospitality industry. However the costs in time and resources associated with rewiring a building with the necessary cables can be substantial. It is, therefore, convenient to provide converters that allow a user to access the network on the existing wiring. Products available from the inventor under the market name of Extreme I and Extreme II can be installed behind an existing face plate and attach directly to the existing wires, and allows a user to access the network through a USB port in the face plate. This requires the installation of the necessary device driver onto the computer, which can be done by either supplying the user with the necessary software, or the USB connection can self-install the necessary software (plug and play). This invention has as an object to provide a converter that operates on the existing wiring with a simple installation but does not require any software installation.

### SUMMARY OF THE INVENTION

The present invention provides a means of connecting a computer with an ethernet connection to a network employing a two-wire system.

There is therefore provided, according to an aspect of the invention, a data port comprising a wall mountable housing and a two-wire to ethernet converter mounted in the wall mountable housing, the two-wire to ethernet converter having a two-wire port, an RJ11 port and a circuit intermediate the two-wire port and the RJ11 port for conversion of data between the two-wire port and the RJ11 port. The two-wire to ethernet converter may connect an ethernet port to the two-wire to ethernet converter, and may further connect the two-wire to ethernet converter to a power source, which may be a USB port, a PS/2 port, or an AC/DC converter connected to an AC power source. The connector may comprise computer cables.

According to another aspect of the invention, the wall mountable housing may be attached to a wall plate by an attachment such that the wall mountable housing is behind the wall plate, the wall plate comprising an opening and a peripheral edge, and the attachment comprising a resilient cantilevered arm extending outwardly from the exterior surface of the housing and forward toward a first end of the housing, the arm having a remote end on which is positioned an upstanding projection; and a projection positioned toward the first end of the housing on the opposite side of the exterior surface as the resilient cantilevered arm.

According to another aspect of the invention, the wall mountable housing may comprise indicator lights for indicating the status of the data port.

According to another aspect of the invention, there is provided a connector for connecting a data port to an information source and for connecting the data port to a power source. The information source may be an ethernet port of a computer. The data port may comprise a wall mountable housing; and a two-wire to ethernet converter mounted in the wall mountable housing, the two-wire to ethernet converter having a two-wire port, an RJ11 port and a circuit intermediate the two-wire port and the RJ11 port for conversion of data between the two-wire port and the RJ11 port. The connector of claim 11 in which the power source may be a USB port of the computer, a PS/2 port of the computer, or an AC/DC adapter connected to an AC power source. The wall mountable housing may comprise indicator lights for indicating the status of the device for converting data. The connector may be comprised of computer cables.

### BRIEF DESCRIPTION OF THE DRAWINGS

There will now be described preferred embodiments of the invention with reference to the figures by way of illustration only and not with the intent of limiting the invention to the precise embodiments disclosed, in which:

FIG. 1 depicts a computer connected to the installed converter;

FIG. 2 depicts a more detailed view of the connection;

FIG. 3 depicts an electrical circuit of the connector and two-wire to ethernet converter.

FIG. 4 depicts the device before installation in a wall plate; and

FIG. 5 gives a perspective view of the device from the front.

### DETAILED DESCRIPTION OF THE INVENTION

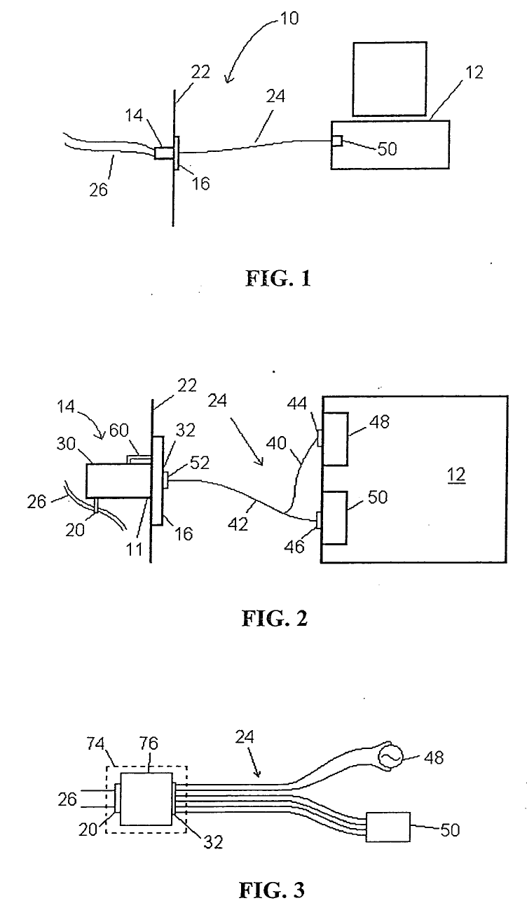

FIG. 1 shows a system 10 that enables a computer 12 with an ethernet port 50 to transmit data on a two-wire system 26. The system 10 comprises a data port 14 for converting data transmitted on an ethernet to data transmitted on a two-wire system 26 A connector or computer cable 24 is shown connecting the device 14 to the computer 12. In FIG. 1, the power source of the data port is not shown, although according to a preferred embodiment, a power source is required. The power source can be any source that allows the device to function. Some examples of possibilities a USB port or a PS/2 port on a computer, or an AC/DC adapter to be plugged into an electrical outlet. Other power sources that are common could also be used, such as a removable battery. More detail is shown in FIG. 2, where the data port 14 is shown to comprise a wall mountable housing 30, and a RJ11 port 32 at a first end 11, or the front end, which will be inserted into an opening in the wall plate 16. This allows the device to be installed in a wall 22 such that it is no more obtrusive than a regular phone jack. A port 20 connects the data port 14 to the two-wire system 26, conveniently shown to be protruding downward at the back of the data port 14 although any location would be suitable. Inside the housing 30 is a circuit 72 that is intermediate the two-wire port and the RJ11 port. The circuit performs the necessary conversion between data conditioned for the ethernet and data conditioned for the two-wire system 26. The circuit can be a phy chip, such is those available from Davicom of Taiwan, although other circuits that perform the same function may also be used. Note that the above installation is intended for common installations where the phone jacks are located in wall plates that are nearly flush with a wall after installation. However, it should be understood that modification to the housing can be made that allow the device to be installed anywhere a phone jack may be located, using the appropriate wall plate or covering to do so. The data port may be installed in the same location as a phone jack, using the same wall plate if wall plates are used. This avoids any interference with phone service to the location.

As stated above, the data port 14 requires power to perform the conversion. According to a preferred embodiment of the invention, the data port 14 can be provided with power by including a connection to a power source with the cable 24 that connects the computer 12 to the data port 14. In one embodiment, this is conveniently accomplished using computer cables such as a USB cable 40 and an ethernet cable 42 and connectors such as USB connector 44 and ethernet connector (RJ45) 46 that are commonly available. A cable design may be used that makes the necessary connections in a convenient manner. The RJ45 jack used in ethernet connections has eight pins, however, only four are used for data transmission. The cable commonly used with ethernet connections has six wires. This leaves two wires unused in the cable, which can be used for power. A USB port 48 is convenient to use as a power source that is located on the computer 12. By connecting the wires that provide the power from the USB port 48 to the two unused wires in the ethernet cable 42, the cable 20 is capable of transmitting power and information. The USB cable can be spliced into the ethernet cable at any point, although it is more convenient to have the splice closer to the computer so that only one cable needs to be extended to the data port. In FIG. 2, the cable 24 is shown to be connected to the USB port 48 acting as the power source through USB jack 44, the ethernet port 50 though RJ45 jack 46, and the data port 14 installed in the wall by the RJ11 jack 52. The USB cable 40 runs between the USB port 48 and the ethernet jack 50, where the power is connected to wires in the ethernet cable 42, which runs between the ethernet jack 50 and the data port 14. Other embodiments which use a PS/2 port or an AC/DC adapter can be formed in a similar manner by replacing the USB connection with the appropriate PS/2 or AC/DC adapter connection, and splicing the wires supplying the power into the ethernet cable.

Referring to FIG. 3, the electrical connections are shown in greater detail. The cable 24 comprises six wires. On one end, four of the wires are connected to the ethernet port 50 for transferring data and two wires are connected to the power source 48 for transferring power. On the other end, the six wires are connected to the two-wire to ethernet converter 74 by the RJ11 port 32, which is of necessity composed of six pin connections. The RJ11 port 32 is connected to the circuit 76 that performs the data conversion, with the power and data connections being made as appropriate. The circuit 76 is then connected to the two-wire system 26 by connector 20.

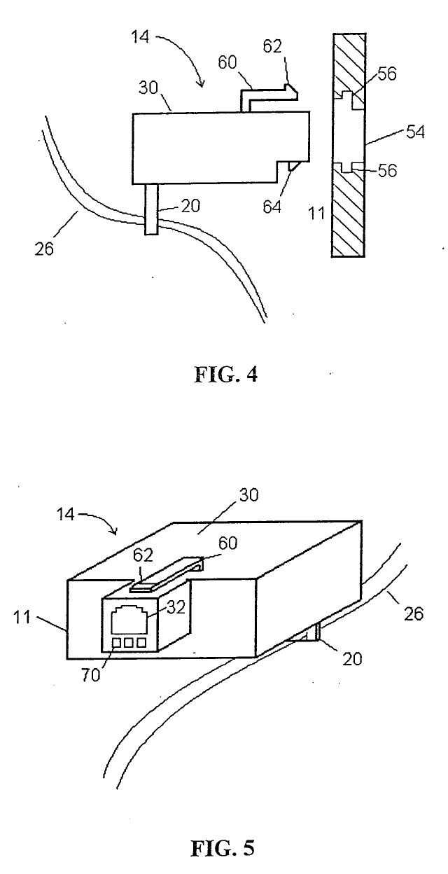

Referring now to FIG. 4, the data port 14 is preferably installed by attaching the housing 30 to a wall plate 16, which has an appropriately sized opening 54 and a peripheral edge 56 in the opening 54. The housing 30 has an attachment 58 comprised of a resilient cantilevered arm 60 extending outwardly from one side of the exterior of the body 30 and forward toward the front end 11 of the housing 30. On the remote end of the arm 60 is positioned an upstanding projection 62. On the opposite side of the housing is positioned another projection 64. In FIG. 4, the cantilevered arm 60 is shown on the top, and the other projection 64 is shown on the bottom. The device 14 is installed by first positioning the projection 64 on the bottom inside the peripheral edge 56, then moving the cantilevered arm 60 until the projection 62 is in the peripheral edge 56 as well.

FIG. 5 shows a front perspective of the data port wall plate. The invention allows for indicator lights 70 to be included in the system 10, shown below the RJ11 port 32 which has been found to be a convenient location for the lights. In FIG. 5, three indicator lights 70 are depicted, which may indicate power, connection, and data transfer although the number of lights and what they indicate may vary according to the intended use.

A person skilled in the art may make immaterial modifications to the invention without departing from the invention.

1. A data port, comprising:
a wall mountable housing; and
a two-wire to ethernet converter mounted in the wall mountable housing, the two-wire to ethernet converter having a two-wire port, an RJ11 port and a circuit intermediate the two-wire port and the RJ11 port for conversion of data between the two-wire port and the RJ11 port.

2. The data port of claim 1 in which the two-wire to ethernet converter further comprises a power source.

3. The data port of claim 2 in which the power source is a USB port.

4. The data port of claim 2 in which the power source is a PS/2 port.

5. The data port of claim 2 in which the power source is an AC/DC adapter connected to an AC power source.

6. The data port of claim 1 in which a connector connects an ethernet port to the two-wire to ethernet converter.

7. The data port of claim 1 in which a connector connects the two-wire to ethernet converter to a power source.

8. The data port of claim 7 in which the connector further connects the two-wire to ethernet converter to a power source comprising a USB port.

9. The data port of claim 7 in which the connector further connects the two-wire to ethernet converter to a power source comprising a PS/2 port.

10. The data port of claim 7 in which the connector further connects the two-wire to ethernet converter to a power source comprising an AC/DC adapter connected to an AC power source.

11. The data port of claim 1 in which the wall mountable housing is mounted on a wall.

12. The data port of claim 11 in which the wall mountable housing is attached to a wall plate for mounting on a wall by an attachment such that the wall mountable housing is behind the wall plate, the wall plate comprising an opening and a peripheral edge, and the attachment comprising:
a resilient cantilevered arm extending outwardly from the exterior surface of the housing and forward toward a first end of the housing, the arm having a remote end on which is positioned an upstanding projection; and
a projection positioned toward the first end of the housing on the opposite side of the exterior surface as the resilient cantilevered arm.

13. The data port of claim 1, the wall mountable housing comprising indicator lights for indicating the status of the data port.

14. A connector for connecting a data port to an information source and for connecting the data port to a power source.

15. The connector of claim 14 in which the information source is an ethernet port of a computer.

16. The connector of claim 15 in which the data port comprises:
a wall mountable housing; and
a two-wire to ethernet converter mounted in the wall mountable housing, the two-wire to ethernet converter having a two-wire port, an RJ11 port and a circuit intermediate the two-wire port and the RJ11 port for conversion of data between the two-wire port and the RJ11 port.

17. The connector of claim 15 in which the power source is a USB port of the computer.

18. The connector of claim 15 in which the power source is a PS/2 port of the computer.

19. The connector of claim 15 in which the power source is an AC/DC converter connected to an AC power source.

20. The connector of claim 16 in which the wall mountable housing comprises indicator lights for indicating the status of the device for converting data.

21. The connector of claim 15 in which the connector is comprised of computer cables.
